(19) United States
(12) Patent Application Publication
(10) Pub. No.: US 2013/0093681 A1
(43) Pub. Date: Apr. 18, 2013

(54) CAPACITIVE TOUCH KEY PANEL

(71) Applicant: LIYITEC INCORPORATED, Gueishan Township (TW)

(72) Inventor: Shu-Jen Hsu, Gueishan Township (TW)

(73) Assignee: LIYITEC INCORPORATED, Gueishan Township (TW)

(21) Appl. No.: 13/646,196

(22) Filed: Oct. 5, 2012

(30) Foreign Application Priority Data
Oct. 13, 2011 (TW) 100137103

(51) Int. Cl. G06F 3/044; G06F 3/02

(52) U.S. Cl. 345/168

(57) ABSTRACT

A capacitive touch key panel has a substrate, at least one key unit, a reference electrode layer and a connection port. The at least one key unit is mounted on the substrate and has a key body and a sensing electrode formed under the key body and being unexposed. The reference electrode layer is formed on the substrate under the key body and separate from the sensing electrode. The connection port has at least one pad formed on the substrate and connecting to the sensing electrode. A user can operate the touch key panel of the invention by touching the key body. Because the sensing electrode is not exposed outside, the sensing electrode is hardly damaged by an external hard object.

### CROSS-REFERENCE TO RELATED APPLICATIONS

This application claims the benefit of Taiwan patent application No. 100137103, filed on Oct. 13, 2011, the disclosure of which is incorporated herein in its entirety by reference.

### BACKGROUND OF THE INVENTION

1. Field of the Invention

The present invention relates to a touch panel, and more particularly to a capacitive touch key panel.

2. Description of Related Art

The electronic products are required to be slim and compact nowadays. The conventional electronic product, such as a mobile phone, has an input device, such as a mechanical keyboard. The keyboard needs spaces for mounting the keys, electronic pads, etc. Therefore, the conventional keyboard is bulky.

For example, with reference to Taiwan patent number M410914, an ultrathin keyboard is disclosed. The inner surface of the flexible button has a conductive film. When the flexible button is pressed, the conductive film contacts the metal wires on a print circuit board. The conductive film acts as an electrical connection between the metal wires. However, if the flexible button has elastic fatigue or if the conductive film is stripped from the flexible button, the conductive film is unable to form the electrical connection, such that signals cannot pass through the metal wires. As a result, the keyboard is out of order.

Beside the mechanical keyboard as mentioned above, another input device, such as a conventional capacitive touch panel, has a substrate, a transparent electrode layer and a cover film. The transparent electrode layer is formed on the substrate. The cover film is mounted on the transparent electrode layer. When the user touches the cover film, a capacitance is induced between the user and the transparent electrode layer. An external device which is connected to the transparent electrode layer can detect the capacitance to determine the position where the user touches on the cover film.

However, the transparent electrode layer and the cover film are easily worn away from the substrate by a hard object or the user's fingernail. When the transparent electrode layer is worn away, the touch panel is functionless. Hence, the conventional touch panel is inconvenient to use.

### SUMMARY OF THE INVENTION

An objective of the present invention is to provide a capacitive touch key panel. The touch key panel has at least one key unit comprising a key body and a sensing electrode. The user can touch the key body to induce a capacitance on the sensing electrodes instead of touching the sensing electrode.

The capacitive touch key panel of the present invention comprises a substrate, at least one key unit, a reference electrode layer and a connection port.

The at least one key unit is mounted on the substrate and has a key body and a sensing electrode. The sensing electrode is formed under the key body.

The reference electrode layer is formed on the substrate under the key body and is separate from the sensing electrode.

The connection port has at least one pad formed on the substrate and connecting to the sensing electrode.

The sensing electrode and the reference electrode layer are adapted to connect to an external device. When the external device provides a working voltage to the sensing electrode and the reference electrode layer, a capacitance is then formed between the sensing electrode and the reference electrode layer. When the user touches the key body, the original capacitance at the key unit is changed. The external device can detect the change of the capacitance and determine that the key body of the key unit is pressed.

The user only touches the key body and cannot directly touch the sensing electrode, which is not exposed externally. Therefore, the sensing electrode and the reference electrode layer are protected from being damaged by the hard object of the user's fingernail.

### BRIEF DESCRIPTION OF THE DRAWINGS

FIG. 1 is a bottom perspective view of the first embodiment of the invention;

FIG. 2A is a bottom view of the first embodiment of the invention;

FIG. 2B is an enlarged top view of the connection port of the invention;

FIG. 3 is a top view of keyboard symbols;

FIG. 4 is a partially cross-sectional view of the second embodiment of the invention;

FIG. 5 is a partially cross-sectional view of the third embodiment of the invention;

FIG. 6 is a partially cross-sectional view of the fourth embodiment of the invention;

FIG. 7 is a partially cross-sectional view of the fifth embodiment of the invention;

FIG. 8 is a partially cross-sectional view of the sixth embodiment of the invention;

FIG. 9 is a partially cross-sectional view of the seventh embodiment of the invention; and

FIG. 10 is a perspective view of a keyboard with the first embodiment of the invention.

### DETAILED DESCRIPTION OF THE PREFERRED EMBODIMENT

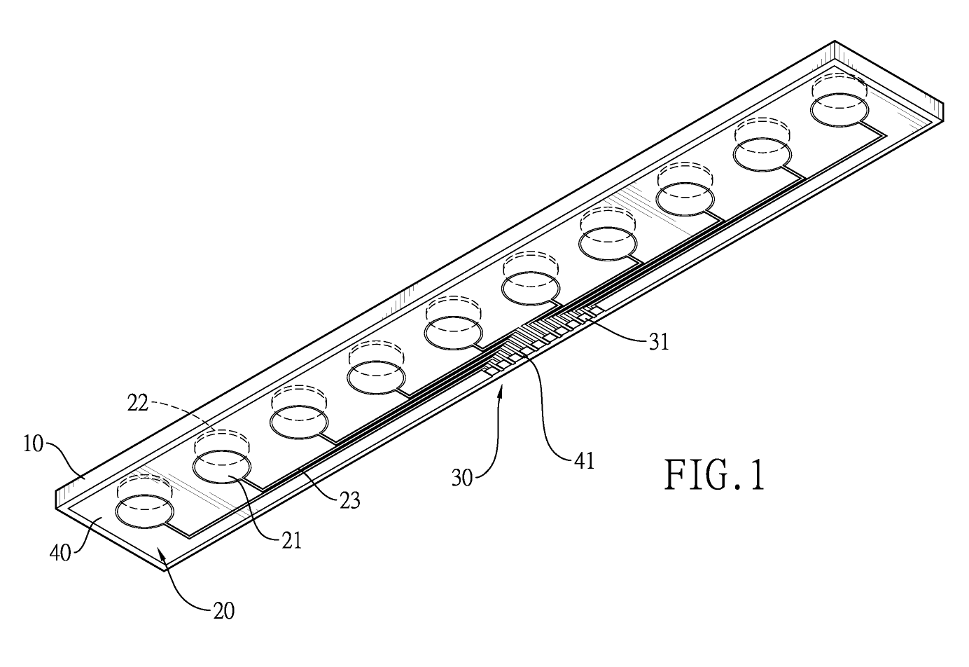

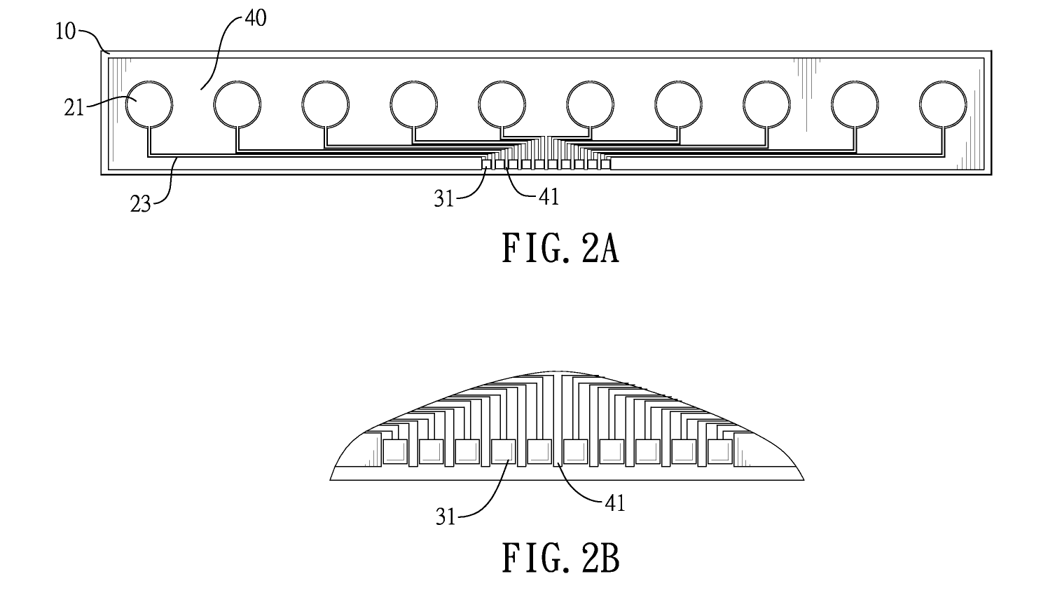

With reference to FIGS. 1 and 2A, a first embodiment of the present invention has a substrate 10, at least one key unit 20, a connection port 30 and a reference electrode layer 40.

The substrate 10 has a top surface and a bottom surface.

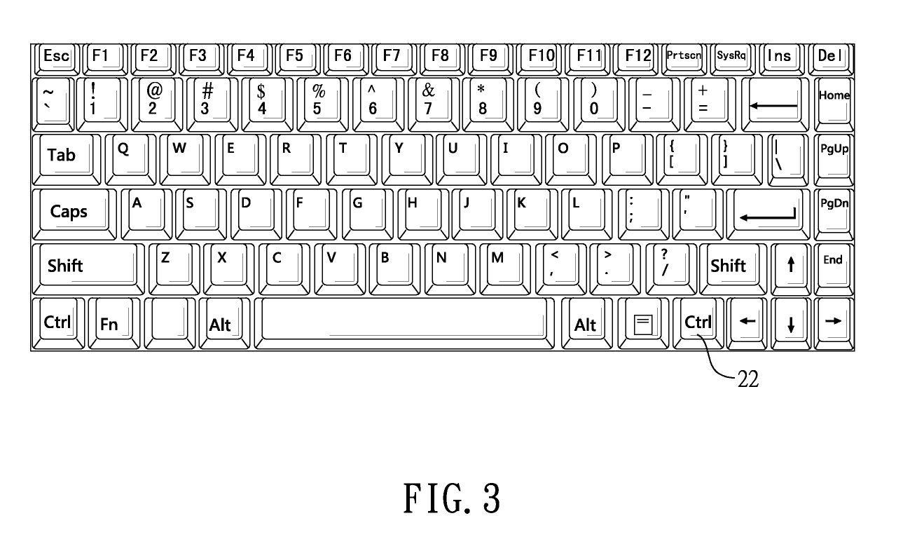

The at least one key unit 20 is mounted on the substrate 10. In this embodiment, the touch panel has multiple key units 20. Each key unit 20 has a sensing electrode 21 and a key body 22. The key body 22 is mounted on the top surface of the substrate 10. The sensing electrode 21 is formed on the bottom surface of the substrate 10 and under the key body 22. The key body 22 can be formed with any pattern, word or symbol for indicating the functions of the key unit 20. For example, with reference to FIG. 3, the patterns of the key bodies 22 can be formed as computer keyboard keys symbol.

With reference to FIGS. 2A and 2B, the connection port 30 is mounted on the bottom surface of the substrate 10 and has multiple pads 31 separate from each other. The pads 31 are respectively connected to the sensing electrodes 21 via wires 23 mounted on the bottom surface of the substrate 10.

The reference electrode layer 40 is formed on the bottom surface of the substrate 10 and is separate from the sensing electrodes 21 and the wires 23 without electrical connection. With reference to FIG. 2B, the reference electrode layer 40 has multiple connection portions 41 extending to the connection port 30 and alternately arranged with the pads 31.

The pads 31 and the connection portions 41 are used to connect to an external device. The external device can provide a positive potential to the pads 31 and ground the connection portions 41 of the reference electrode layer 40. A capacitance is then formed between the sensing electrode 21 and the reference electrode layer 40. When a user touches the key body 22 by an object such as a finger, the electric charge on the finger changes the original capacitance between the sensing electrode 21 and the reference electrode layer 40. Hence, the external device detects the change of the capacitance to determine which key body 22 is pressed by the user.

The user touches the key body 22 on the top surface of the substrate 10 instead of directly contacting the sensing electrodes 21, the reference electrode layer 40 and the wires 23 which are formed or mounted on the bottom surface of the substrate 10. Therefore, the sensing electrodes 21, the reference electrode layer 40 and the wires 23 are protected from being damaged by the user's abnormal operation or by the object.

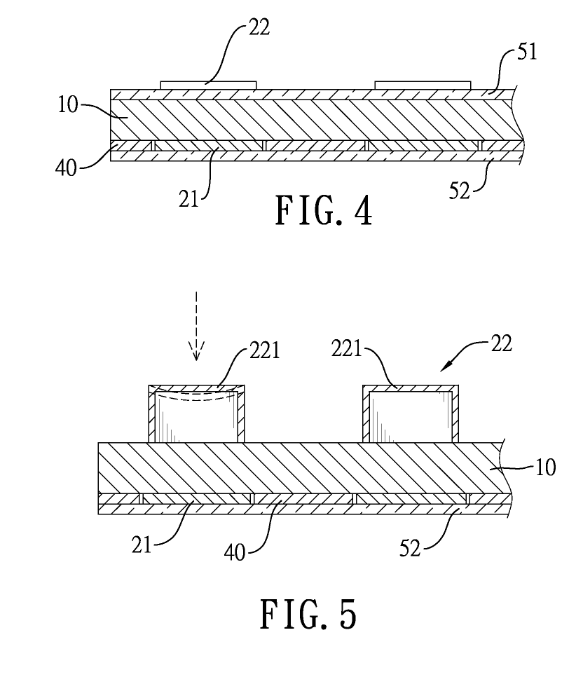

With reference to FIG. 4, a second embodiment of the present invention comprises a cover layer 51 and a protection layer 52. The cover layer 51 is mounted on the top surface of the substrate 10. The key body 22 is mounted on the cover layer 51. The protection layer 52 is formed under the substrate 10 to cover the sensing electrodes 21, the reference electrode layer 40 and the wires 23.

With reference to FIG. 5, the key body 22 of a third embodiment of the invention is mounted on the top surface of the substrate 10 and can be hollow and has a flexible touch portion 221. The sensing electrode 21 is under the flexible touch portion 221. When the user presses the flexible touch portion 221 with 5-200 grams pressure, the flexible touch portion 221 becomes concave. After the user releases the flexible touch portion 221, the flexible touch portion 221 returns to the original state. Hence, the flexible touch portion 221 of the embodiment acts like a real button.

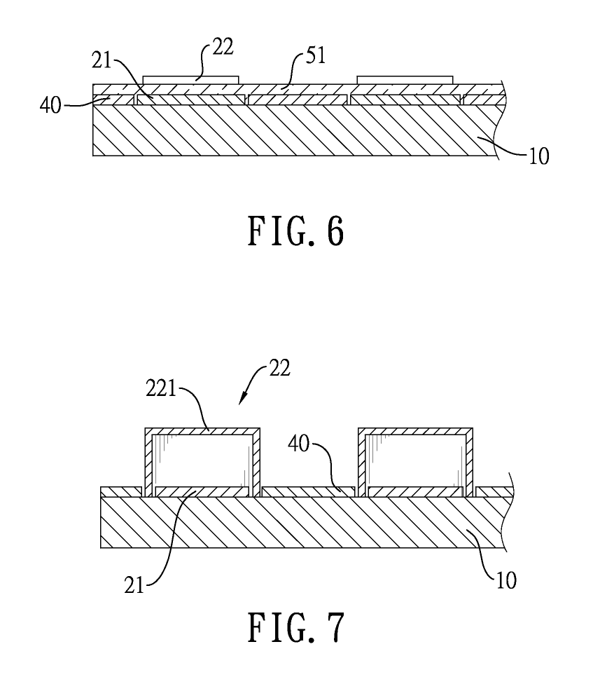

With reference to FIG. 6, a fourth embodiment of the invention has a cover layer 51. The sensing electrodes 21, the reference electrode layer 40 and the wires are formed or mounted on the top surface of the substrate 10. The cover layer 51 covers the sensing electrodes 21, the reference electrode layer 40 and the wires. The key bodies 22 are mounted on the cover layer 51 and respectively correspond to the sensing electrodes 21. The colors of the cover layer 51 and the key bodies 22 are different. Hence, the user can easily distinguish the positions of the key bodies 22 by their colors.

With reference to FIG. 7, a fifth embodiment of the invention is disclosed. The sensing electrodes 21, the wires and the reference electrode layer 40 are formed or mounted on the top surface of the substrate 10. The key bodies 22 are mounted on the top surface of the substrate 10 and cover the sensing electrodes 21. The flexible touch portions 221 are respectively above the sensing electrodes 21.

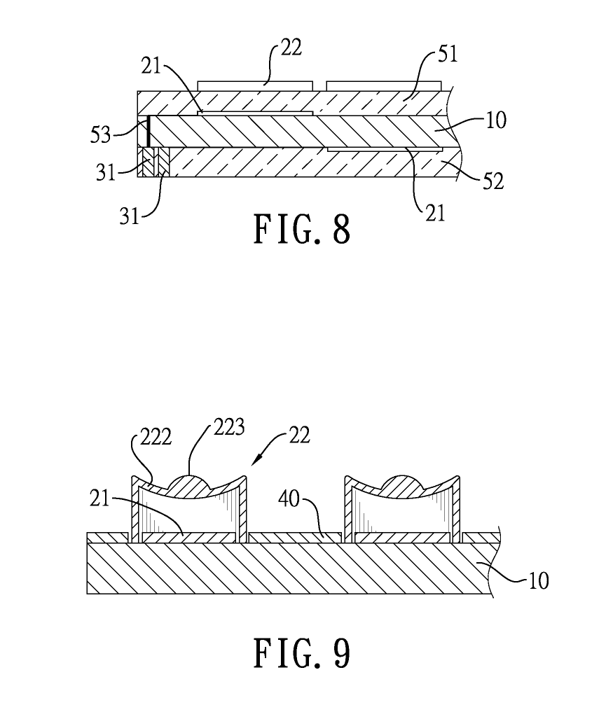

With reference to FIG. 8, a sixth embodiment of the invention is disclosed. The substrate 10 has at least one conductive hole 53. At least one sensing electrode 21 is formed on the top surface of the substrate 10. The at least one sensing electrode 21 on the top surface of the substrate 10 is electrically connected to at least one pad 31 through the at least one conductive hole 53. The cover layer 51 is mounted on the top surface of the substrate 10 to cover the at least one sensing electrode 21 which is formed on the top surface of the substrate 10. The other sensing electrodes 21 are formed on the bottom surface of the substrate 10 and are electrically connected to the other pads 31. The protection layer 52 is mounted on the bottom surface of the substrate 10 to cover the sensing electrodes 21 which are formed on the bottom surface of the substrate 10.

In this embodiment, the conductive hole 53 is embedded in the substrate 10 and is not exposed externally. The conductive hole 53 will not be disrupted by an external hard object, such as a shell.

With reference to FIG. 9, a seventh embodiment of the invention is disclosed. The sensing electrodes 21, the wires and the reference electrode layer 40 are formed or mounted on the top surface of the substrate 10. The key bodies 22 are hollow and are mounted on the top surface of the substrate 10 to respectively cover the sensing electrodes 21. Each key body 22 has a concave surface 222 above the sensing electrode 21 and a protrusion 223 formed on the concave surface 222. When the user touches the protrusion 223 of one of the key bodies 22 by an object, the closest sensing electrode 21 under the object is activated. The protrusion 223 keeps the object away from other sensing electrodes 21. Therefore, other sensing electrodes 21 will not be activated. The external device only detects the key unit 20 that is pressed by the user. The misoperation between the key units 20 is avoided.

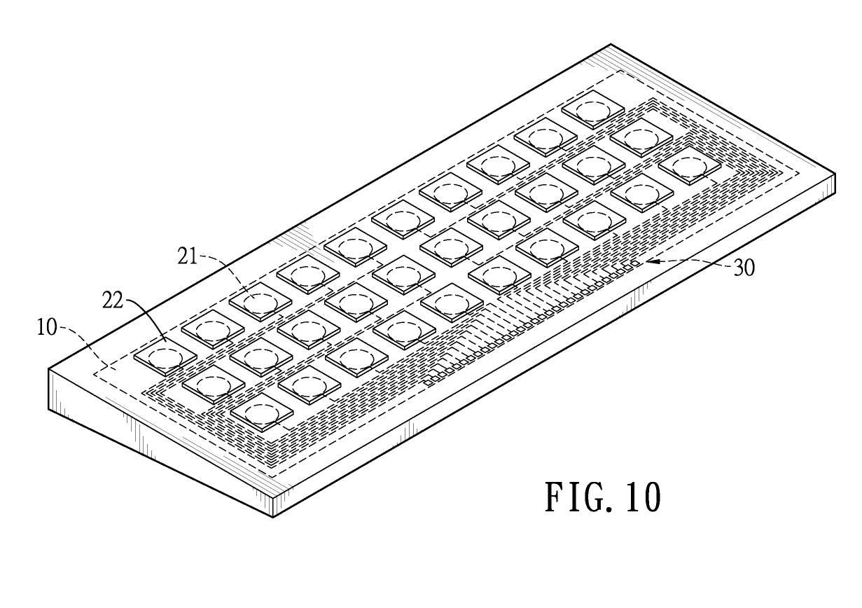

With reference to FIG. 10, the touch panel of the present invention can be installed in a keyboard to replace the conventional keyboard keys. Because the substrate 10 is thin, the present invention is smaller in volume and lighter in weight than the conventional keyboard. The sensing electrodes 21 are not exposed externally. When the user operates the touch panel of the invention, the user touches the key bodies 22 on the top surface of the substrate 10 instead of touching the sensing electrodes 21. Hence, the sensing electrodes 21 will not be damaged by the user.

What is claimed is:

1. A capacitive touch key panel comprising:
a substrate;
at least one key unit mounted on the substrate and having
a key body; and
a sensing electrode formed under the key body;
a reference electrode layer formed on the substrate under the key body and separate from the sensing electrode; and
a connection port having at least one pad formed on the substrate and connecting to the sensing electrode.

2. The capacitive touch key panel as claimed in claim 1, wherein:
the substrate has a top surface and a bottom surface;
the key body is mounted on the top surface of the substrate; and
the sensing electrode, the reference electrode layer and the connection port are formed on the bottom surface of the substrate.

3. The capacitive touch key panel as claimed in claim 1 further comprising a cover layer, wherein:
the substrate has a top surface and a bottom surface;
the cover layer is mounted on the top surface of the substrate;
the key body is mounted on the cover layer; and
the sensing electrode is formed on the bottom surface of the substrate.

4. The capacitive touch key panel as claimed in claim 3 further comprising a protection layer formed under the substrate to cover the sensing electrode and the reference electrode layer.

5. The capacitive touch key panel as claimed in claim 1, wherein:
the substrate has a top surface and a bottom surface;
the key body is mounted on the top surface of the substrate and has a flexible touch portion; and
the sensing electrode and the reference electrode layer are formed on the bottom surface of the substrate.

6. The capacitive touch key panel as claimed in claim 1 further comprising a cover layer, wherein:
the substrate has a top surface;
the sensing electrode and the reference electrode layer are formed on the top surface of the substrate;
the cover layer covers the sensing electrode and the reference electrode layer; and
the key body is formed on the cover layer.

7. The capacitive touch key panel as claimed in claim 1, wherein:
the substrate has a top surface;
the sensing electrode and the reference electrode body are formed on the top surface of the substrate; and
the key body is mounted on the top surface of the substrate, covers the sensing electrode and has a flexible touch portion above the sensing electrode.

8. The capacitive touch key panel as claimed in claim 1, wherein:
the substrate has a top surface;
the sensing electrode and the reference electrode layer are formed on the top surface of the substrate; and
the key body is mounted on the top surface of the substrate to cover the sensing electrode and has:
a concave surface above the sensing electrode; and
a protrusion formed on the concave surface.

9. The capacitive touch key panel as claimed in claim 1 having multiple key units and multiple pads and further comprising a cover layer and a protection layer, wherein:
the substrate has a top surface, a bottom surface and at least one conductive hole;
the pads are formed on the bottom surface of the substrate;
the sensing electrode of at least one key unit is formed on the top surface of the substrate and is connected to at least one pad through the conductive hole;
the sensing electrodes of the other key units are formed on the bottom surface of the substrate;
the cover layer is mounted on the top surface of the substrate to cover the sensing electrode which is formed on the top surface of the substrate;
the protection layer is mounted on the bottom surface of the substrate to cover the sensing electrodes which are formed on the bottom surface of the substrate; and
the key bodies of the key units are mounted on the cover layer and respectively correspond to the sensing electrodes.
